(19) United States
(12) Patent Application Publication
(10) Pub. No.: US 2026/0120040 A1
(43) Pub. Date: Apr. 30, 2026

(54) MODELING METHOD AND SYSTEM FOR CARBON EMISSIONS IN LEATHER MANUFACTURING PROCESS

(71) Applicant: SICHUAN UNIVERSITY, Chengdu City (CN)

(72) Inventors: Wei LIN, Chengdu City (CN); Minmin LIU, Chengdu City (CN); Chunhua WANG, Chengdu City (CN); Jianfei ZHOU, Chengdu City (CN); Bi SHI, Chengdu City (CN)

(73) Assignee: SICHUAN UNIVERSITY, Chengdu City (CN)

(21) Appl. No.: 18/927,523

(22) Filed: Oct. 25, 2024

(51) Int. Cl. G06Q 10/067; G06Q 50/04

(52) U.S. Cl. CPC G06Q 10/067; G06Q 50/04

(57) ABSTRACT

Embodiments of the disclosure provide modeling methods and systems for carbon emissions in leather manufacturing processes. In some examples, firstly, various carbon emission sources are determined in the leather manufacturing process, including four types: an energy type emission source (E), a production process type emission source (P), a transportation process type emission source (T), and a waste type emission source (W). Masses and carbon emission factors of the four types of emission sources in the sections are obtained. Carbon emission accounting models for different sections are constructed based on the masses and the carbon emission factors of the carbon emission sources in the sections. On this basis, the modeling system for carbon emission in a leather manufacturing process is constructed with a parameter acquisition module, a model construction module, and a model assessment module.

### FIELD OF THE DISCLOSURE

The disclosure relates generally to the field of carbon accounting. More specifically, the disclosure relates to modeling methods and systems for carbon emissions in leather manufacturing processes.

### BACKGROUND

The modern society has increasingly urgent requirements on environmental protection and sustainable development. Carbon emissions have become an important environmental problem on a global scale. Leather manufacturing is an important industrial field, which face challenges in terms of the carbon emission problem. The process of making a leather product involves multiple stages, including raw material acquisition, production and processing, energy consumption, waste disposal, and the like. These parts might have influences on carbon emissions. However, existing research and analysis methods on carbon emissions in the leather manufacturing process still have many limitations.

Therefore, to solve the problems in the prior art, there is a need for a modeling method and system for carbon emissions in the leather manufacturing process that can analyze and assess carbon emissions comprehensively and accurately. The method and system may obtain carbon emissions of different sections based on actual data and an accounting model, determine which sections have the greatest influences on carbon emissions, find a potential of emission reduction, and develop a corresponding emission reduction strategy. On this basis, an accounting model for carbon emissions throughout the entire leather manufacturing process is constructed. By meticulous analysis and monitoring on the carbon footprint, a decision maker may be guided to take effective measures in different fields to promote the fulfillment of the goals of carbon dioxide peaking and carbon neutrality.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, the present disclosure provides a modeling method and system for carbon emissions in a leather manufacturing process. Here, 4 types of emission sources are included: an energy type emission source (E), a production process type emission source (P), a transportation process type emission source (T), and a waste type emission source (W). The energy type emission source (E) includes carbon emissions generated in activities such as heating and drying using fossil fuels such as coal, petroleum, and natural gas in the leather manufacturing process. The production process type emission source (P) includes carbon emissions generated by leather chemical materials used in different making sections of the leather manufacturing process. The transportation process type emission source (T) includes carbon emissions generated by road transport involved in the leather manufacturing process. The waste type emission source (W) includes carbon emissions generated in treatment processes of waste water, waste gas, and leather making leftover materials in the leather manufacturing process.

In other embodiments, the leather manufacturing process includes a preparation section, a tanning section, a wet processing section after tanning, and a finishing section. The preparation section includes steps of storage, batching, water immersion, degreasing, liming, deliming, acid soaking, softening, and the like. The tanning section includes steps of tanning with various metals, non-metal tanning, combined tanning, and the like. The wet processing section after tanning includes steps of retanning, dyeing, fat liquoring, and the like. The finishing section includes steps of drying, softening by rolling, ironing, finishing, and the like.

In further embodiments, carbon emission accounting models for leather making sections are constructed based on masses and carbon emission factors of the 4 types of emission sources in the sections of the leather manufacturing process. The carbon emission accounting model for each leather making section is as shown in the following Formula (1):

$${E}_{section} = {E}_{energy} + {P}_{process} + {T}_{transportation} + {W}_{waste} \qquad ( 1 )$$

$${E}_{energy} = \sum ( {C}_{k} \times {H}_{k} ) + EA \times EF + HA \times HF \qquad ( 1 - 1 )$$

$${P}_{process} = \sum i ( {PM}_{i} \times {PF}_{i} ) \qquad ( 1 - 2 )$$

$${T}_{transportation} = \sum i ( {TM}_{i} \times {TF}_{i} \times {TD}_{i} ) \qquad ( 1 - 3 )$$

$${W}_{waste} = \sum i ( {WM}_{i} \times {WF}_{i} ) \qquad ( 1 - 4 )$$

Here, E_{section} represents carbon emissions of each section in the leather manufacturing process, E_{energy} represents carbon emissions of the energy type emission source, P_{process} represents carbon emissions of the production process type emission source, Tₜᵣₐₙₛₚₒᵣₜₐₜᵢₒₙ represents carbon emissions of the transportation process type emission source, W_{waste} represents carbon emissions of the waste type emission source, Cₖ represents a consumption of the k-th type of fuel in the leather manufacturing process, Hₖ represents a carbon emission factor for the k-th type of fuel in the leather manufacturing process, EA represents activity level data of purchased electric power in the leather manufacturing process, EF represents a carbon emission factor for the purchased electric power in the leather manufacturing process, HA represents activity level data of purchased heat in the leather manufacturing process, HF represents a carbon emission factor for the purchased heat in the leather manufacturing process, PMᵢ represents a mass of the i-th type of raw material consumed in the leather manufacturing process, PFᵢ represents a carbon emission factor for the i-th type of raw material in the leather manufacturing process, TMᵢ represents a mass of the i-th type of raw material transported in the leather manufacturing process, TFᵢ represents a carbon emission factor for the i-th type of mode of transportation in the leather manufacturing process, TDᵢ represents a transport mileage of the i-th type of raw material in the leather manufacturing process, WMᵢ represents a mass of the i-th type of waste disposed in the leather manufacturing process, and WFᵢ represents a carbon emission factor for disposal of the i-th type of waste in the leather manufacturing process.

Optionally, a carbon emission accounting model for the entire leather manufacturing process is constructed based on the carbon emission accounting models for the leather making sections, as shown in the following Formula (2):

$$\sum E ( i ) = {E}_{section 1} + {E}_{section 2} + {E}_{section 3} + {E}_{section 4} \qquad ( 2 )$$

Here, ΣE(i) represents carbon emissions in the whole leather manufacturing process, E_{section 1} represents the preparation section, E_{section 2} represents the tanning section, E_{section 3} represents the wet processing section after tanning, and E_{section 4} represents the finishing section.

Optionally, a modeling system for carbon emissions in a leather manufacturing process includes following components.
(1) a parameter acquisition module configured to acquire masses and carbon emission factors of energy type emission sources (E), production process type emission sources (P), transportation process type emission sources (T), and waste type emission sources (W) of different sections in the leather manufacturing process and read carbon emissions of different types of emission sources in the leather manufacturing process to pre-constructed carbon emission accounting models for the sections.
(2) a model construction module configured to sum carbon emissions of 4 types of emission sources in the leather manufacturing process to construct models, the model construction module having a function of extracting carbon emissions in different sections of the leather manufacturing process.
(3) a model assessment module configured to construct an interval model based on upper and lower limit values of certain parameters in a calculation process. The interval model is capable of obtaining a range of an assessment result by taking all cases within a calculated parameter range into comprehensive consideration.

Optionally, the model construction module includes following components.
(1) an energy type emission source model construction sub-module configured to construct, based on masses of a fuel, purchased electric power, and purchased heat of the energy type emission sources, and carbon emission factors thereof in different sections of the leather manufacturing process, a carbon emission accounting model for the energy type emission sources of the sections.
(2) a process production type emission source model construction sub-module configured to construct, based on masses of raw materials consumed of the production process type emission sources, and carbon emission factors thereof in different sections of the leather manufacturing process, a carbon emission accounting model for the production process type emission sources of the sections.
(3) a transportation process type emission source model construction sub-module configured to construct, based on masses of raw materials transported of the transportation process type emission sources, and carbon emission factors thereof, and transport mileages of raw materials in different sections of the leather manufacturing process, a carbon emission accounting model for the transportation process type emission sources of the sections.
(4) a waste type emission source model construction sub-module configured to construct, based on masses of wastes disposed of the waste type emission sources, and carbon emission factors thereof in different sections of the leather manufacturing process, a carbon emission accounting model for the waste type emission sources of the sections.

In the modeling system for carbon emissions in a leather manufacturing process, the sub-modules of an energy type emission source model, a production process type emission source model, a transportation process type emission source type and a waste type emission source model for different sections are called to extract carbon emissions of the corresponding sections.

### BRIEF DESCRIPTION OF THE DRAWINGS

Illustrative embodiments of the present disclosure are described in detail below with reference to the attached drawing figures.

FIG. 1 shows a flowchart of a modeling method for carbon emissions in a leather manufacturing process according to an embodiment of the disclosure.

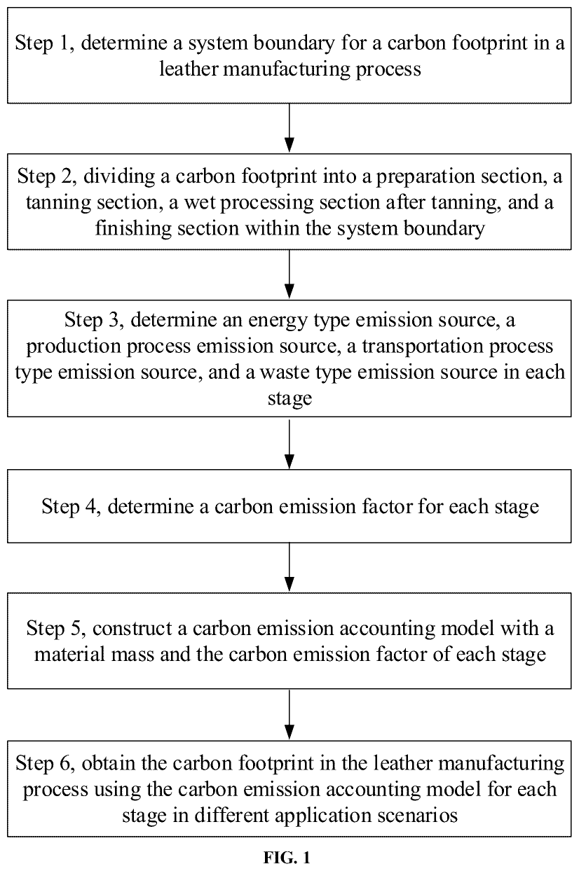

FIG. 2 shows a flowchart of a modeling system for carbon emissions in a leather manufacturing process according to an embodiment of the disclosure.

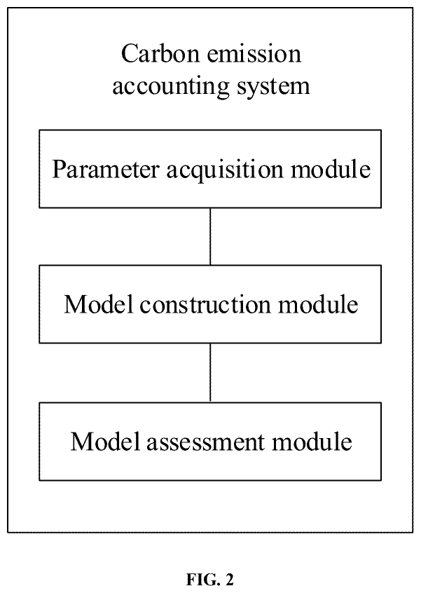

FIG. 3 shows a boundary diagram of a leather manufacturing process according to an embodiment of the disclosure.

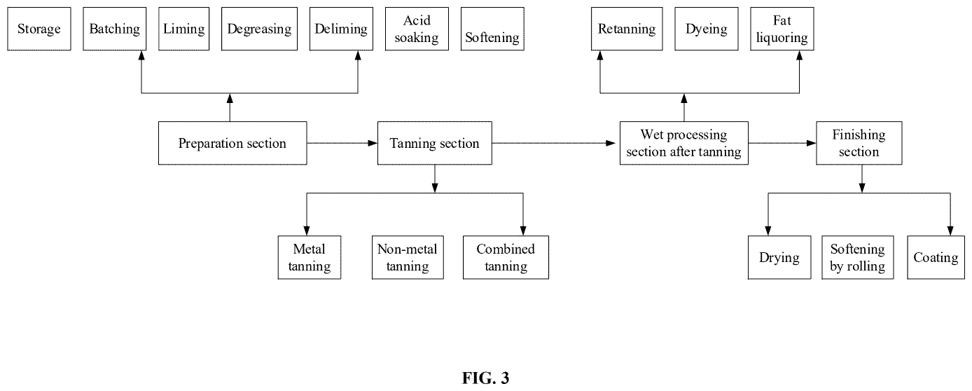

### DETAILED DESCRIPTION

The following describes some non-limiting exemplary embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

### Example 1

1. A modeling method and system for carbon emissions in a preparation-tanning section of pigskin leather manufacturing may include 4 types of emission sources: an energy type emission source (E), a production process type emission source (P), a transportation process type emission source (T), and a waste type emission source (W). The energy type emission source (E) may include carbon emissions generated in activities such as heating and drying using fossil fuels such as coal, petroleum, and natural gas in the preparation-tanning section of pigskin leather manufacturing. The production process type emission source (P) may include carbon emissions generated by leather chemical materials used in the preparation-tanning section of pigskin leather manufacturing. The transportation process type emission source (T) may include carbon emissions generated by road transport involved in the preparation-tanning section of pigskin leather manufacturing. The waste type emission source (W) may include carbon emissions generated in treatment processes of waste water, waste gas, and leather making leftover materials in the preparation-tanning section of pigskin leather manufacturing.

The preparation-tanning section of pigskin leather manufacturing may include a preparation section including steps of batching, water immersion, fleshing, degreasing, unhairing (mechanical hair pulling or biological unhairing), liming, priming, re-liming, deliming, softening, acid soaking, and the like, and a tanning section including a step of chromium tanning or chromium-free tanning.

A carbon emission accounting model for the preparation-tanning section of pigskin leather manufacturing is constructed based on masses and carbon emission factors of the 4 types of emission sources in the preparation-tanning section of pigskin leather manufacturing. The carbon emission accounting model for the preparation section of pigskin leather manufacturing is as shown in the following Formula (1):

$${E}_{section 1} = {E}_{energy} + {P}_{process} + {T}_{transportation} + {W}_{waste} \qquad ( 1 )$$

$${E}_{energy} = \sum ( {C}_{k} \times {H}_{k} ) + EA \times EF + HA \times HF \qquad ( 1 - 1 )$$

$${P}_{process} = \sum i ( {PM}_{i} \times {PF}_{i} ) \qquad ( 1 - 2 )$$

$${T}_{transportation} = \sum i ( {TM}_{i} \times {TF}_{i} \times {TD}_{i} ) \qquad ( 1 - 3 )$$

$${W}_{waste} = \sum i ( {WM}_{i} \times {WF}_{i} ) \qquad ( 1 - 4 )$$

Here, E_{section 1} represents the preparation section of pigskin leather manufacturing, E_{energy} represents carbon emissions of the energy type emission source, P_{process} represents carbon emissions of the production process type emission source, Tₜᵣₐₙₛₚₒᵣₜₐₜᵢₒₙ represents carbon emissions of the transportation process type emission source, W_{waste} represents carbon emissions of the waste type emission source, Cₖ represents a consumption of the k-th type of fuel in the preparation section of pigskin leather manufacturing, Hₖ represents a carbon emission factor for the k-th type of fuel in the preparation section of pigskin leather manufacturing, EA represents activity level data of purchased electric power in the preparation section of pigskin leather manufacturing, EF represents a carbon emission factor for the purchased electric power in the preparation section of pigskin leather manufacturing, HA represents activity level data of purchased heat in the preparation section of pigskin leather manufacturing, HF represents a carbon emission factor for the purchased heat in the preparation section of pigskin leather manufacturing, PMᵢ represents a mass of the i-th type of raw material consumed in the preparation section of pigskin leather manufacturing, PFᵢ represents a carbon emission factor for the i-th type of raw material in the preparation section of pigskin leather manufacturing, TMᵢ represents a mass of the i-th type of raw material transported in the preparation section of pigskin leather manufacturing, TFᵢ represents a carbon emission factor for the i-th type of mode of transportation in the preparation section of pigskin leather manufacturing, TDᵢ represents a transport mileage of the i-th type of raw material in the preparation section of pigskin leather manufacturing, WMᵢ represents a mass of the i-th type of waste disposed in the preparation section of pigskin leather manufacturing, and WFᵢ represents a carbon emission factor for disposal of the i-th type of waste in the preparation section of pigskin leather manufacturing.

A carbon emission accounting model for the tanning section of pigskin leather manufacturing is as shown in the following Formula (2):

$${E}_{section 2} = {E}_{energy} + {P}_{process} + {T}_{transportation} + {W}_{waste} \qquad ( 1 )$$

$${E}_{energy} = \sum ( {C}_{k} \times {H}_{k} ) + EA \times EF + HA \times HF \qquad ( 1 - 1 )$$

$${P}_{process} = \sum i ( {PM}_{i} \times {PF}_{i} ) \qquad ( 1 - 2 )$$

$${T}_{transportation} = \sum i ( {TM}_{i} \times {TF}_{i} \times {TD}_{i} ) \qquad ( 1 - 3 )$$

$${W}_{waste} = \sum i ( {WM}_{i} \times {WF}_{i} ) \qquad ( 1 - 4 )$$

Here, E_{section 2} represents the tanning section of pigskin leather manufacturing, E_{energy} represents carbon emissions of the energy type emission source, P_{process} represents carbon emissions of the production process type emission source, Tₜᵣₐₙₛₚₒᵣₜₐₜᵢₒₙ represents carbon emissions of the transportation process type emission source, W_{waste} represents carbon emissions of the waste type emission source, Cₖ represents a consumption of the k-th type of fuel in the tanning section of pigskin leather manufacturing, Hₖ represents a carbon emission factor for the k-th type of fuel in the tanning section of pigskin leather manufacturing, EA represents activity level data of purchased electric power in the tanning section of pigskin leather manufacturing, EF represents a carbon emission factor for the purchased electric power in the tanning section of pigskin leather manufacturing, HA represents activity level data of purchased heat in the tanning section of pigskin leather manufacturing, HF represents a carbon emission factor for the purchased heat in the tanning section of pigskin leather manufacturing, PMᵢ represents a mass of an ith raw material consumed in the tanning section of pigskin leather manufacturing, PFᵢ represents a carbon emission factor for the i-th type of raw material in the tanning section of pigskin leather manufacturing, TMᵢ represents a mass of the i-th type of raw material transported in the tanning section of pigskin leather manufacturing, TFᵢ represents a carbon emission factor for the i-th type of mode of transportation in the tanning section of pigskin leather manufacturing, TDᵢ represents a transport mileage of the ith raw material in the tanning section of pigskin leather manufacturing, WMᵢ represents a mass of the i-th type of waste disposed in the tanning section of pigskin leather manufacturing, and WFᵢ represents a carbon emission factor for disposal of the i-th type of waste in the tanning section of pigskin leather manufacturing.

A carbon emission accounting model for the preparation-tanning section of pigskin leather manufacturing is as shown in the following Formula (3):

$$\sum E ( i ) = {E}_{section 1} + {E}_{section 2}$$

E₂ represents carbon emissions generated by the preparation-tanning section of pigskin leather manufacturing, E_{section 1} represents the preparation section of pigskin leather manufacturing, and E_{section 2} represents the tanning section of pigskin leather manufacturing. Meanwhile, grease and meat residues produced in the fleshing step of the preparation section and the lime-treated skin leftover materials produced in the priming step may be used as raw materials for extraction of grease and collagen. Therefore, this part can share carbon emissions according to a weight and an economic value.
2. A modeling system for carbon emissions in a preparation-tanning section of pigskin leather manufacturing may include following components.
(1) a parameter acquisition module configured to acquire masses and carbon emission factors of energy type emission sources (E), production process type emission sources (P), transportation process type emission sources (T), and waste type emission sources (W) of the preparation-tanning section of pigskin leather manufacturing, and read carbon emissions of different types of emission sources in the leather manufacturing process to a pre-constructed carbon emission accounting model for the preparation-tanning section of pigskin leather manufacturing.
(2) a model construction module configured to sum carbon emissions of 4 types of emission sources in the preparation-tanning section of pigskin leather manufacturing to construct models.
(3) a model assessment module configured to construct an interval model based on upper and lower limit values of certain parameters in a calculation process. The interval model is capable of obtaining a range of an assessment result by taking all cases within a calculated parameter range into comprehensive consideration.
3. The model construction module may include following components.
(1) an energy type emission source model construction sub-module configured to construct, based on masses of a fuel, purchased electric power, and purchased heat of the energy type emission sources, and carbon emission factors thereof in the preparation-tanning section of pigskin leather manufacturing, a carbon emission accounting model for the energy type emission sources of the preparation-tanning section.
(2) a process production type emission source model construction sub-module configured to construct, based on masses of raw materials consumed of the production process type emission sources, and carbon emission factors thereof in the preparation-tanning section of pigskin leather manufacturing, a carbon emission accounting model for the production process type emission sources of the preparation-tanning section.
(3) a transportation process type emission source model construction sub-module configured to construct, based on masses of raw materials transported of the transportation process type emission sources, and carbon emission factors thereof, and transport mileages of raw materials in the preparation-tanning section of pigskin leather manufacturing, a carbon emission accounting model for the transportation process type emission sources of the preparation-tanning section.
(4) a waste type emission source model construction sub-module configured to construct, based on masses of wastes disposed of the waste type emission sources, and carbon emission factors thereof in the preparation-tanning section of pigskin leather manufacturing, a carbon emission accounting model for the waste type emission sources of the preparation-tanning section.
4. In the modeling system for carbon emissions in a leather manufacturing process, the sub-modules of an energy type emission source model, a production process type emission source model, a transportation process type emission source type and a waste type emission source model for the preparation-tanning section of pigskin leather manufacturing are called to extract carbon emissions of the corresponding preparation-tanning section of pigskin leather manufacturing.

### Example 2

1. A modeling method and system for carbon emissions in a cowhide sofa leather manufacturing process include 4 types of emission sources: an energy type emission source (E), a production process type emission source (P), a transportation process type emission source (T), and a waste type emission source (W). The energy type emission source (E) may include carbon emissions generated in activities such as heating and drying using fossil fuels such as coal, petroleum, and natural gas in the leather manufacturing process. The production process type emission source (P) may include carbon emissions generated by leather chemical materials used in different making sections of the cowhide sofa leather manufacturing process. The transportation process type emission source (T) may include carbon emissions generated by road transport involved in the cowhide sofa leather manufacturing process. The waste type emission source (W) may include carbon emissions generated in treatment processes of waste water, waste gas, and leather making leftover materials in the cowhide sofa leather manufacturing process.

The cowhide sofa leather manufacturing process may include a preparation section, a tanning section, a wet processing section after tanning, and a finishing section. The preparation section may include steps of batching, water immersion, fleshing, liming, deliming, softening, acid soaking, and the like. The tanning section may include a step of chromium tanning or chromium-free tanning. The wet processing section after tanning may include steps of grading, squeezing water, splitting, shaving, retanning, neutralizing, filling, dyeing, fat liquoring, and the like. The finishing section may include steps of drying, priming, intermediate coating, knurling, softening by rolling, ironing, top coating, finished product grading, and the like.

Carbon emission accounting models for leather making sections are constructed based on masses and carbon emission factors of the 4 types of emission sources in the sections of the cowhide sofa leather manufacturing process. The carbon emission accounting model for each leather making section is as shown in the following Formula (1):

$${E}_{section} = {E}_{energy} + {P}_{process} + {T}_{transportation} + {W}_{waste} \qquad ( 1 )$$

$${E}_{energy} = \sum ( {C}_{k} \times {H}_{k} ) + EA \times EF + HA \times HF \qquad ( 1 - 1 )$$

$${P}_{process} = \sum i ( {PM}_{i} \times {PF}_{i} ) \qquad ( 1 - 2 )$$

$${T}_{transportation} = \sum i ( {TM}_{i} \times {TF}_{i} \times {TD}_{i} ) \qquad ( 1 - 3 )$$

$${W}_{waste} = \sum i ( {WM}_{i} \times {WF}_{i} ) \qquad ( 1 - 4 )$$

A carbon emission accounting model for the whole cowhide sofa leather manufacturing process is constructed based on the carbon emission accounting models for the leather making sections, as shown in the following Formula (2):

$$\sum E ( i ) = {E}_{section 1} + {E}_{section 2} + {E}_{section 3} + {E}_{section 4} \qquad ( 2 )$$

Here, ΣE(i) represents carbon emissions in the whole cowhide sofa leather manufacturing process, E_{section 1} represents the preparation section, E_{section 2} represents the tanning section, E_{section 3} represents the wet processing section after tanning, and E_{section 4} represents the finishing section.

The carbon emissions in the whole process are calculated. In the above formula, E_{section 1} represents carbon emissions in the preparation section of the cowhide sofa leather manufacturing process, E_{section 2} represents carbon emissions in the tanning section of the cowhide sofa leather manufacturing process, E_{section 3} represents carbon emissions in the wet processing section after tanning of the cowhide sofa leather manufacturing process, E_{section 4} represents carbon emissions in the finishing section of the cowhide sofa leather manufacturing process, E_{energy} represents carbon emissions of the energy type emission source, and the carbon emissions of the energy type emission sources of the 4 sections are calculated, denoted by E_{energy 1}, E_{energy 2}, E_{energy 3}, E_{energy 4}, P_{process} represents carbon emissions of the production process type emission source, and the carbon emissions of the production process type emission sources of the 4 sections are calculated, denoted by P_{process 1}, P_{process 2}, P_{process 3}, P_{process 4}, Tₜᵣₐₙₛₚₒᵣₜₐₜᵢₒₙ represents carbon emissions of the transportation process type emission source, and the carbon emissions of the transportation process type emission sources of the 4 sections are calculated, denoted by T_{transportation 1}, T_{transportation 2}, T_{transportation 3}, T_{transportation 4}, F_{waste} represents carbon emissions of the waste type emission source, and the carbon emissions of the waste type emission sources of the 4 sections are calculated, denoted by W_{waste 1}, W_{waste 2}, W_{waste 3}, W_{waste 4}, Cₖ represents a consumption of a kth fuel in each section of the cowhide sofa leather manufacturing process, Hₖ represents a carbon emission factor for the k-th type of fuel in the cowhide sofa leather manufacturing process, EA represents activity level data of purchased electric power in the cowhide sofa leather manufacturing process, EF represents a carbon emission factor for the purchased electric power in the cowhide sofa leather manufacturing process, HA represents activity level data of purchased heat in the cowhide sofa leather manufacturing process, HF represents a carbon emission factor for the purchased heat in the cowhide sofa leather manufacturing process, PMᵢ represents a mass of the i-th type of raw material consumed in the cowhide sofa leather manufacturing process, PFᵢ represents a carbon emission factor for the i-th type of raw material in the cowhide sofa leather manufacturing process, TMᵢ represents a mass of the i-th type of raw material transported in the cowhide sofa leather manufacturing process, TFᵢ represents a carbon emission factor for the i-th type of mode of transportation in the cowhide sofa leather manufacturing process, TDᵢ represents a transport mileage of the i-th type of raw material in the cowhide sofa leather manufacturing process, WMᵢ represents a mass of the i-th type of waste disposed in the cowhide sofa leather manufacturing process, and WFᵢ represents a carbon emission factor for disposal of the i-th type of waste in the cowhide sofa leather manufacturing process.

$${E}_{section 1} + {E}_{energy 1} + {E}_{process 1} + {T}_{transportation 1} + {W}_{waste 1}$$

$${E}_{section 2} + {E}_{energy 2} + {E}_{process 2} + {T}_{transportation 2} + {W}_{waste 2}$$

$${E}_{section 3} + {E}_{energy 3} + {E}_{process 3} + {T}_{transportation 3} + {W}_{waste 3}$$

$${E}_{section 4} + {E}_{energy 4} + {E}_{process 4} + {T}_{transportation 4} + {W}_{waste 4}$$

$$\sum E ( 4 ) = {E}_{section 1} + {E}_{section 2} + {E}_{section 3} + {E}_{section 4}$$

E₄ represent carbon missions generated in the preparation section, the tanning section, the wet processing section after tanning, and the finishing section of the cowhide sofa leather manufacturing process. Meanwhile, split leather generated in the splitting step of the wet processing section after tanning may be used or sold as a coproduct, and carbon emissions generated thereby may be shared according to an economic value.
2. A modeling system for carbon emissions in a cowhide sofa leather manufacturing process may include following components.
(1) a parameter acquisition module configured to acquire masses and carbon emission factors of energy type emission sources (E), production process type emission sources (P), transportation process type emission sources (T), and waste type emission sources (W) of the sections in the cowhide sofa leather manufacturing process, and read carbon emissions of different types of emission sources in the cowhide sofa leather manufacturing process to pre-constructed carbon emission accounting models for the sections.
(2) a model construction module configured to sum carbon emissions of 4 types of emission sources in the sections in the cowhide sofa leather manufacturing process to construct models.
(3) a model assessment module configured to construct an interval model based on upper and lower limit values of certain parameters in a calculation process. The interval model is capable of obtaining a range of an assessment result by taking all cases within a calculated parameter range into comprehensive consideration.
3. The model construction module may include following components.
(1) an energy type emission source model construction sub-module configured to construct, based on masses of a fuel, purchased electric power, and purchased heat of the energy type emission sources, and carbon emission factors thereof in the sections of the cowhide sofa leather manufacturing process, a carbon emission accounting model for the energy type emission sources of the sections.
(2) a process production type emission source model construction sub-module configured to construct, based on masses of raw materials consumed of the production process type emission sources, and carbon emission factors thereof in the sections of the cowhide sofa leather manufacturing process, a carbon emission accounting model for the production process type emission sources of the sections.
(3) a transportation process type emission source model construction sub-module configured to construct, based on masses of raw materials transported of the transportation process type emission sources, and carbon emission factors thereof, and transport mileages of raw materials in the sections of the cowhide sofa leather manufacturing process, a carbon emission accounting model for the transportation process type emission sources of the sections.
(4) a waste type emission source model construction sub-module configured to construct, based on masses of wastes disposed of the waste type emission sources, and carbon emission factors thereof in the sections of the cowhide sofa leather manufacturing process, a carbon emission accounting model for the waste type emission sources of the sections.
4. In the modeling system for carbon emissions in a cowhide sofa leather manufacturing process, the sub-modules of an energy type emission source model, a production process type emission source model, a transportation process type emission source type and a waste type emission source model for different sections are called to extract carbon emissions of the corresponding sections, and the carbon emissions are summed to obtain the carbon emissions of all the sections.

Various embodiments of the disclosure may have one or more of the following effects. In some embodiments, in order to solve the existing problems of inaccurate calculation results and inaccurate calculation of carbon emissions in different sections due to a complicated leather manufacturing process, the present disclosure may provide a modeling method and system for carbon emissions in a leather manufacturing process. Here, 4 types of emission sources are included: an energy type emission source (E), a production process type emission source (P), a transportation process type emission source (T), and a waste type emission source (W). In some embodiments, the leather manufacturing process refers to a process of making fur and leather products or finished products with a variety of animal skins as raw materials. In further embodiments, the disclosure may help to establish a modeling method and system for carbon emissions in a leather manufacturing process.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. A modeling method for carbon emissions in a leather manufacturing process, wherein:
carbon emission sources in the leather manufacturing process comprise four types of emission sources: an energy type emission source (E), a production process type emission source (P), a transportation process type emission source (T), and a waste type emission source (W);
the energy type emission source (E) comprises carbon emissions generated in heating and drying activities using fossil fuels coal, petroleum, and natural gas in the leather manufacturing process;
the production process type emission source (P) comprises carbon emissions generated by leather chemical materials used in different making sections of the leather manufacturing process;
the transportation process type emission source (T) comprises carbon emissions generated by road transport involved in the leather manufacturing process;
the waste type emission source (W) comprises carbon emissions generated in treatment processes of waste water, waste gas, and leather making leftover materials in the leather manufacturing process;
the leather manufacturing process comprises a preparation section, a tanning section, a wet processing section after tanning, and a finishing section;
the preparation section comprises steps of storage, batching, water immersion, degreasing, liming, deliming, acid soaking, and softening;
the tanning section comprises steps of tanning with various metals, non-metal tanning, and combined tanning;
the wet processing section after tanning comprises steps of retanning, dyeing, and fat liquoring;
the finishing section comprises steps of drying, softening by rolling, ironing, and finishing;
carbon emission accounting models for leather making sections are constructed based on masses and carbon emission factors of the four types of emission sources in sections of the leather manufacturing process;
the carbon emission accounting model for each leather making section is as shown in following Formula (1):
$${E}_{section} = {E}_{energy} + {P}_{process} + {T}_{transportation} + {W}_{waste} , \qquad ( 1 )$$
$${E}_{energy} = \sum ( {C}_{k} \times {H}_{k} ) + EA \times EF + HA \times HF , \qquad ( 1 - 1 )$$
$${P}_{process} = \sum i ( {PM}_{i} \times {PF}_{i} ) , \qquad ( 1 - 2 )$$
$${T}_{transportation} = \sum i ( {TM}_{i} \times {TF}_{i} \times {TD}_{i} ) , and \qquad ( 1 - 3 )$$
$${W}_{waste} = \sum i ( {WM}_{i} \times {WF}_{i} ) , \qquad ( 1 - 4 )$$
wherein:
E_{section} represents carbon emissions of each section in the leather manufacturing process,
E_{energy} represents carbon emissions of the energy type emission source,
P_{process} represents carbon emissions of the production process type emission source,
Tₜᵣₐₙₛₚₒᵣₜₐₜᵢₒₙ represents carbon emissions of the transportation process type emission source,
W_{waste} represents carbon emissions of the waste type emission source,
Cₖ represents a consumption of a k-th type of fuel in the leather manufacturing process,
Hₖ represents a carbon emission factor for the k-th type of fuel in the leather manufacturing process,
EA represents activity level data of purchased electric power in the leather manufacturing process,
EF represents a carbon emission factor for the purchased electric power in the leather manufacturing process,
HA represents activity level data of purchased heat in the leather manufacturing process,
HF represents a carbon emission factor for the purchased heat in the leather manufacturing process,
PMᵢ represents a mass of an i-th type of raw material consumed in the leather manufacturing process,
PFᵢ represents a carbon emission factor for the i-th type of raw material in the leather manufacturing process,
TMᵢ represents a mass of the i-th type of raw material transported in the leather manufacturing process,
TFᵢ represents a carbon emission factor for the i-th type of mode of transportation in the leather manufacturing process,
TDᵢ represents a transport mileage of the i-th type of raw material in the leather manufacturing process,
WMᵢ represents a mass of the i-th type of waste disposed in the leather manufacturing process, and
WFᵢ represents a carbon emission factor for disposal of the i-th type of waste in the leather manufacturing process; and
a carbon emission accounting model for an entire leather manufacturing process is constructed based on the carbon emission accounting models for the leather making sections, as shown in following Formula (2):
$$\sum E ( i ) = {E}_{section 1} + {E}_{section 2} + {E}_{section 3} + {E}_{section 4} , \qquad ( 2 )$$
wherein:
ΣE(i) represents carbon emissions in a whole leather manufacturing process,
E_{section 1} represents the preparation section,
E_{section 2} represents the tanning section,
E_{section 3} represents the wet processing section after tanning, and
E_{section 4} represents the finishing section.

2. The modeling method according to claim 1, wherein the leather manufacturing process is a process of making fur and leather products or finished products with a variety of animal skins as raw materials.

3. A modeling system for carbon emissions in a leather manufacturing process, comprising:
(1) a parameter acquisition module configured to acquire masses and carbon emission factors of energy type emission sources (E), production process type emission sources (P), transportation process type emission sources (T), and waste type emission sources (W) of different sections in the leather manufacturing process, and to read carbon emissions of different types of emission sources in the leather manufacturing process to pre-constructed carbon emission accounting models for the sections;
(2) a model construction module configured to sum carbon emissions of four types of emission sources in the leather manufacturing process to construct models, the model construction module having a function of extracting carbon emissions in different sections of the leather manufacturing process; and
(3) a model assessment module configured to construct an interval model based on upper and lower limit values of certain parameters in a calculation process, wherein the interval model is configured to obtain a range of an assessment result by taking all cases within a calculated parameter range into comprehensive consideration.

4. The modeling system according to claim 3, wherein the model construction module comprises:
(1) an energy type emission source model construction sub-module configured to construct, based on masses of a fuel, purchased electric power, and purchased heat of the energy type emission sources, and carbon emission factors thereof in different sections of the leather manufacturing process, a carbon emission accounting model for the energy type emission sources of the sections;
(2) a process production type emission source model construction sub-module configured to construct, based on masses of raw materials consumed of the production process type emission sources, and carbon emission factors thereof in different sections of the leather manufacturing process, a carbon emission accounting model for the production process type emission sources of the sections;
(3) a transportation process type emission source model construction sub-module configured to construct, based on masses of raw materials transported of the transportation process type emission sources, and carbon emission factors thereof, and transport mileages of raw materials in different sections of the leather manufacturing process, a carbon emission accounting model for the transportation process type emission sources of the sections; and
(4) a waste type emission source model construction sub-module configured to construct, based on masses of wastes disposed of the waste type emission sources, and carbon emission factors thereof in different sections of the leather manufacturing process, a carbon emission accounting model for the waste type emission sources of the sections.

5. The modeling system according to claim 3, wherein sub-modules of an energy type emission source model, a production process type emission source model, a transportation process type emission source model, and a waste type emission source model for different sections are called to extract carbon emissions of corresponding sections.

6. The modeling system according to claim 3, wherein the leather manufacturing process is a process of making fur and leather products or finished products with a variety of animal skins as raw materials.
